(19) United States
(12) Patent Application Publication
(10) Pub. No.: US 2015/0293890 A1
(43) Pub. Date: Oct. 15, 2015

(54) Method, device and system for webpage transcoding

(71) Applicants: BEIJING QIHOD TECHNOLOGY COMPANY LIMITED, Beijing (CN); QIZHI SOFTWARE (BEIJING) COMPANY LIMITED, Beijing (CN)

(72) Inventors: Yuanjiang Zhou, Beijing (CN); Bo Lu, Beijing (CN)

(21) Appl. No.: 14/434,436

(22) PCT Filed: Aug. 16, 2013
(86) PCT No.: PCT/CN2013/081628

§ 371 Date: Apr. 9, 2015

(30) Foreign Application Priority Data
Oct. 12, 2012 (CN) 201210387245.5

(51) Int. Cl. G06F 17/22; G06F 17/27; G06F 17/30

(52) U.S. Cl. CPC G06F 17/2258; G06F 17/30905; G06F 17/272; G06F 17/2247

(57) ABSTRACT

This disclosure discloses a method, device and system for webpage transcoding. The method comprises: obtaining a Hypertext Markup Language (HTML) document from a target website based on a client request; parsing the HTML document, and when it is detected that the HTML document contains picture information, notifying a picture processor and downloading individual sub-resources except for the picture information from the target website; transcoding the downloaded individual sub-resources, and sending them to the client after the completion of transcoding, wherein reserving a typesetting space for the picture information when transcoding; obtaining the picture information in the HTML document fed back by the picture processor, and transcoding the picture information and then sending it to the client. In this disclosure, the function of downloading picture information is handled by a picture processor, rather than a transcoding server, thereby realizing a transition of the transcoding procedure from a traditional serial processing mode to a parallel processing mode, saving resources of the transcoding server, and greatly improving the throughput and response capacities.

### FIELD OF THE INVENTION

The disclosure relates to the field of Internet technology, and in particular, to a method, device and system for webpage transcoding.

### BACKGROUND OF THE INVENTION

As shown in FIG. 1, a server for webpage transcoding re-typesets (namely, transcodes) a webpage in order that the webpage has a good display effect on a small screen mobile device, and will generally use a private protocol to further compress flow. Nowadays, a way of a transcoding server implementing transcoding is as shown in FIG. 2, and the particular transcoding workflow comprises:

step 1: a client sending a request for accessing a webpage to the transcoding server;

step 2: the transcoding server sending a request for an HTML (Hypertext Markup Language) document to a target website after receiving the request for accessing a webpage;

step 3: the target website responding to the request for an HTML document;

step 4: the transcoding server parsing the HTML document and obtaining individual sub-resources to be downloaded; wherein the individual sub-resources comprise, but are not limited to, a script, a picture and a CSS (Cascading Style Sheet);

step 5: the transcoding server downloading the individual sub-resources from the target website;

step 6: the transcoding server transcoding the downloaded individual sub-resources, and after the completion of transcoding, sending them to the client as a response to the client's request.

It can be seen from the above transcoding workflow that, after the completion of parsing the HTML document, the transcoding server downloads individual sub-resources obtained by parsing, and transcodes the individual sub-resources, that is to say, the whole transcoding procedure is a procedure of serial processing, and the transcoding operation will be done only after the completion of downloading all the sub-resources. Such a way of serial processing is still applicable for individual sub-resources not containing picture information which occupies a relatively large space. However, when the sub-resources contain ones for which the download is relatively time-consuming, such as picture information, etc., the adoption of serial processing will greatly affect the transcoding efficiency (since the picture data is often large, and consumes the longest time).

### SUMMARY OF THE INVENTION

In view of the above problems, the disclosure is proposed to provide a method, device and system for webpage transcoding, which overcome the above problems or at least in part solve the above problems.

According to an aspect of the disclosure, there is provided a method for webpage transcoding comprising:

obtaining a Hypertext Markup Language HTML document from a target website based on a client request;

parsing the HTML document, and when it is detected that the HTML document contains picture information, notifying a picture processor and downloading individual sub-resources except for the picture information from the target website;

transcoding the downloaded individual sub-resources, and sending them to the client after the completion of transcoding, wherein reserving a typesetting space for the picture information when transcoding; and

obtaining the picture information in the HTML document fed back by the picture processor, and transcoding the picture information and then sending it to the client.

According to another aspect of the disclosure, there is provided a transcoding server comprising:

a request processing unit configured to receive a request for accessing a webpage from a client and obtain an HTML document from a target website based on the request;

a parsing & processing unit configured to parse the HTML document, and when it is detected that the HTML document contains picture information, notify a picture processor and download individual sub-resources except for the picture information from the target website;

a transcoding unit configured to transcode the downloaded individual sub-resources, and send them to the client after the completion of transcoding, wherein reserve a typesetting space for the picture information when transcoding; and

a picture responding unit configured to obtain the picture information in the HTML document fed back by the picture processor, and transcode the picture information and then send it to the client.

According to a further aspect of the disclosure, there is provided a picture processor comprising:

a notification message receiving unit configured to receive a notification message for obtaining picture information sent by a transcoding server;

a picture obtaining unit configured to detect whether picture information requested to be obtained by a transcoding server has been cached in it, and if yes, feed the cached picture information back to the transcoding server; or otherwise, download the picture information from a target website and then feed it back to the transcoding server; and

a cache unit configured to cache locally picture information downloaded from the target website.

According to a further aspect of the disclosure, there is provided a client comprising:

a webpage requesting unit configured to send a request message for accessing a webpage to a transcoding server;

a first display unit configured to receive individual sub-resources sent by the transcoding server for webpage display which are transcoded and have a reserved picture typesetting space; and

a second display unit configured to receive transcoded picture information sent by the transcoding server, and display the picture information in the reserved picture typesetting space.

According to a still further aspect of the disclosure, there is provided a system for webpage transcoding comprising: the transcoding server of the disclosure, the picture processor of the disclosure, and the client of the disclosure.

The beneficial effects of the disclosure lie in that:

In the technical solution of this disclosure, the function of downloading picture information is handled by the picture processor, rather than the transcoding server, then the transcoding server need not wait for the complete download of the picture information before it can do webpage typesetting, such that the client may receive a response more rapidly so as to begin drawing page content; whereas after obtaining picture information sent by the picture processor, the transcoding server transcodes the picture information and then sends it to the client, and at this point, the client only needs to perform an update operation for picture information in a drawn page, which greatly improves the request response efficiency. For the client, it also need not send an additional number of requests, which will not waste network flow generated by the requests.

In addition, in the technical solution of this disclosure, the picture processor employs a cache mechanism, thereby reducing the number of accessing a target website and improving the processing capability of the system.

The above description is merely an overview of the technical solutions of the disclosure. In the following particular embodiments of the disclosure will be illustrated in order that the technical means of the disclosure can be more clearly understood and thus may be embodied according to the content of the specification, and that the foregoing and other objects, features and advantages of the disclosure can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the disclosure. And throughout the drawings, like reference signs are used to denote like components. In the drawings:

FIG. 1 is a principle diagram of a deployment of a server for webpage transcoding;

FIG. 2 is a flow chart of transcoding of a transcoding server in the prior art;

FIG. 3 is a flow chart of a method for webpage transcoding provided by the first embodiment of the disclosure;

FIG. 4 is a flow chart of another method for webpage transcoding provided by the first embodiment of the disclosure;

FIG. 5 is a webpage with a reserved typesetting space displayed by a client in the first embodiment of the disclosure;

FIG. 6 is a webpage in which picture information in the reserved typesetting space is updated by the client in the first embodiment of the disclosure;

FIG. 7 is a structural schematic diagram of a transcoding server provided by the second embodiment of the disclosure;

FIG. 8 is a structural schematic diagram of a picture processor provided by the third embodiment of the disclosure;

FIG. 9 is a structural schematic diagram of a client provided by the fourth embodiment of the disclosure;

FIG. 10 is a structural schematic diagram of a system for webpage transcoding provided by the fifth embodiment of the disclosure;

FIG. 11 shows schematically a block diagram of a server configured to perform a method according to the disclosure; and

FIG. 12 shows schematically a storage unit configured to retain or carry a program code implementing a method according to the disclosure.

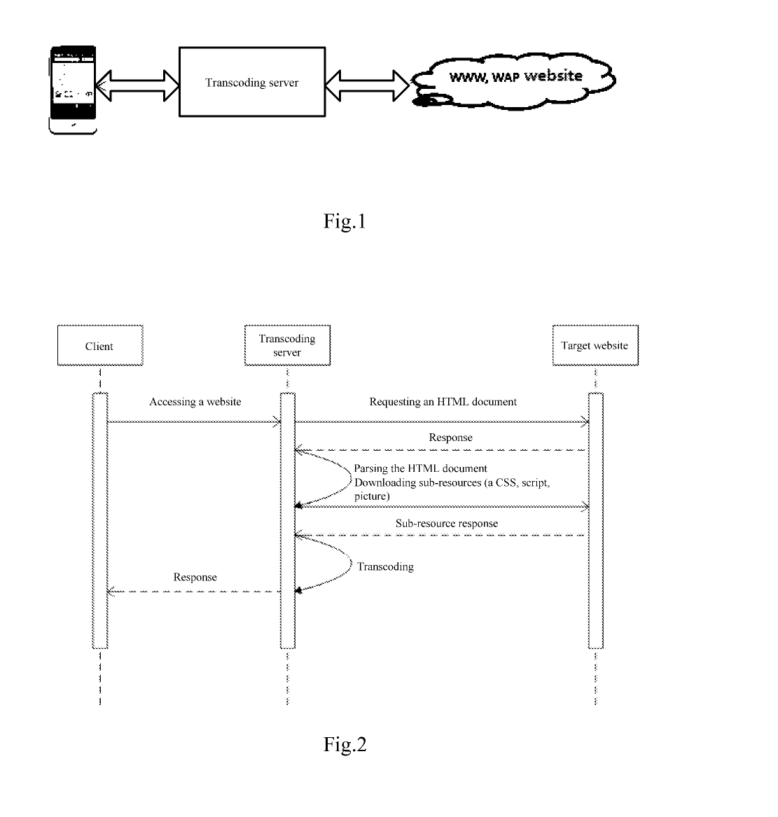

### DETAILED DESCRIPTION OF THE INVENTION

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

In order to solve the problem of a low transcoding efficiency with the method for webpage transcoding employed in the prior art, embodiments of the disclosure provide a method, device and system for webpage transcoding.

The basic principle of the method, device and system of the embodiments of the disclosure lies in that: for the processing of picture information, a picture processor is introduced, and the picture processor separates the procedure of downloading a picture out of a transcoding server, such that the transcoding server does not wait for the completion of picture download, and sends individual sub-resources except for the picture information which have been downloaded and transcoded to a client, such that the client first displays the individual sub-resources except for the picture information; after receiving the picture information sent by the picture processor, the transcoding server transcodes it and then sends it to the client, and the client then performs resource update for the currently displayed webpage.

It can be seen that, the embodiments of the disclosure change a traditional serial processing mode to a parallel processing mode, save resources of the transcoding server, and greatly improve the throughput and response capacities of the transcoding server.

In the following, particular implementation procedures of the disclosure will be described in detail through several embodiments.

### First Embodiment

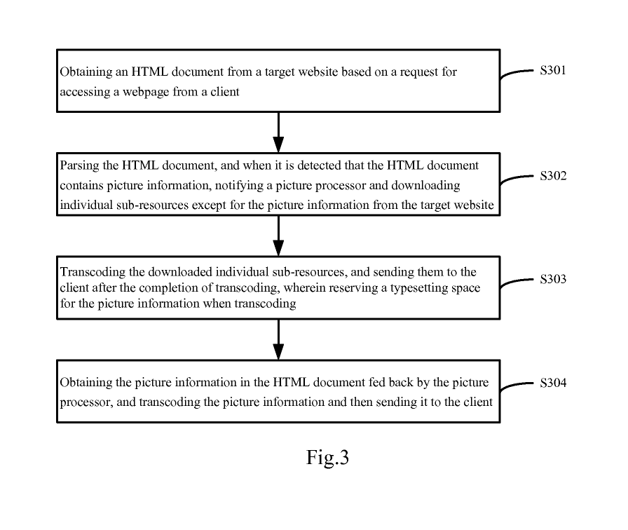

As shown in FIG. 3, the embodiment of the disclosure provides a method for webpage transcoding, which in particular comprises the following steps.

In step S301, an HTML document is obtained from a target website based on a request for accessing a webpage from a client.

In step S302, the HTML document is parsed, and when it is detected that the HTML document contains picture information, a picture processor is notified and individual sub-resources except for the picture information are downloaded from the target website.

In this step, notifying a picture processor particularly refers to notifying the picture processor to obtain the picture information and give a feedback.

In this step, the procedure of downloading individual sub-resources except for the picture information and the procedure of the picture processor obtaining the picture information after it is notified are a parallel processing procedure.

In step S303, the downloaded individual sub-resources are transcoded, and sent to the client after the completion of transcoding, wherein a typesetting space is reserved for the picture information when transcoding.

In this step, reserving a typesetting space for the picture information when transcoding particularly comprises:

detecting whether the size information of a picture is contained in the parsed HTML document, and if yes, reserving a typesetting space for the picture information based on the size information; otherwise, reserving a typesetting space for the picture information based on a preset fixed size.

Furthermore, in this step, when reserving a typesetting space for the picture information, the ID of the reserved typesetting space is set to match the ID of the picture information.

Furthermore, in this step, when the transcoded individual sub-resources are sent to the client, they carry a picture-to-be-transmitted indicator for instructing the client to maintain the current connection, and in turn ensuring that the whole actions of the method of the disclosure are done in one HTTP response.

Furthermore, in this step, after receiving the transcoded individual resources, the client displays a local default picture in the reserved typesetting space. Preferably, the local default picture displayed by the client is a waiting-for-download identification picture.

In step S304, the picture information in the HTML document fed back by the picture processor is obtained, and the picture information is transcoded and then sent to the client.

In this step, the picture information fed back by the picture processor may be obtained employing, but not limited to, one of the following two ways, wherein the embodiment of the disclosure preferably employs the second way:

first way: the picture processor directly downloads the picture information from the target website after receiving the notification; and

second way: the picture processor applies a cache technique, which is particularly that:

the picture processor detects whether the processor itself has cached the picture information after receiving the notification, and if yes, obtains the cached picture information and feeds it back; otherwise, downloads the picture information from the target website, and obtains the downloaded picture information and feeds it back.

Furthermore, in this step, when the picture information is obtained, the typesetting space reserved for the picture information is obtained in particular according to the ID information of the picture information, and the picture information is transcoded based on the reserved typesetting space.

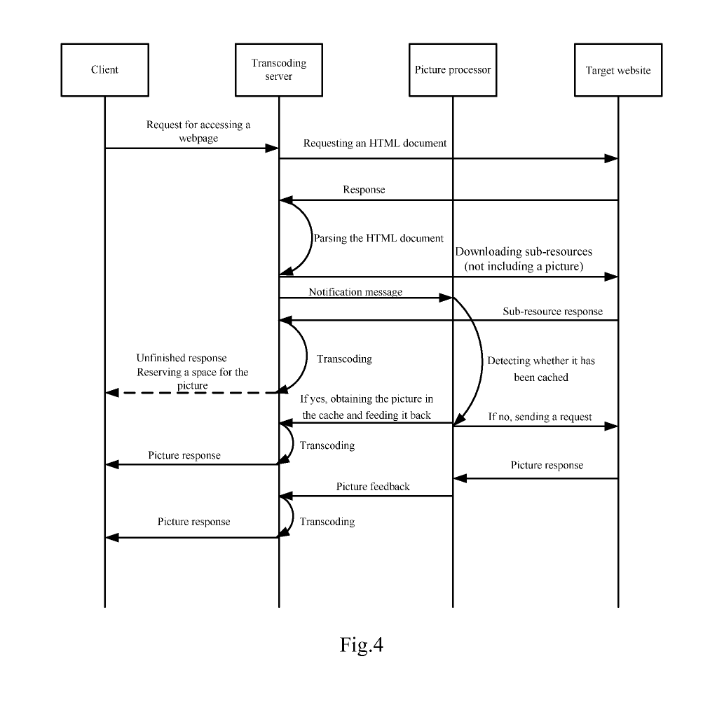

In the following, the method of the embodiment of the disclosure will be further described in detail in connection with FIGS. 4-6.

As shown in FIG. 4, the method for webpage transcoding provided by the embodiment of the disclosure particularly comprises the following steps.

In step 1, the client sends a request message for accessing a webpage to the transcoding server.

In step 2, the transcoding server sends a request for an HTML document to the target website after receiving the request for accessing a webpage.

In step 3, the target website responds to the request for an HTML document.

In step 4, the transcoding server parses the HTML document, obtains individual sub-resources to be downloaded, and when the sub-resources contain picture information, notifies the picture processor, and downloads other individual sub-resources except for the picture information from the target website.

In step 5, after downloading the individual sub-resources except for the picture information, the transcoding server performs a transcoding operation, and reserves a typesetting space for the picture information when transcoding.

In this step, a particular implementation of reserving a typesetting space for the picture information may be:

detecting whether the size information of a picture is contained in the parsed HTML document, and if yes, reserving a typesetting space for the picture information based on the size information; otherwise, reserving a typesetting space for the picture information based on a preset fixed size; at the same time, setting IDs for the picture information and the reserved typesetting space, and causing the two IDs to be associated and match with each other.

As an example, assuming that in this step, the obtained size information of the picture is 200×100, namely:

<html>

. . .

<img src=“http://images.example.com/sample.jpg” width=“200” height=“100”/>

. . .

</html>

the transcoding server considers the picture has been downloaded when typesetting, reserves a space of 200×100 for the picture and numbers the picture (i.e., ID of the picture).

In step 6, the transcoding server sends the individual sub-resources which have a reserved typesetting space to the client after the completion of transcoding.

In this step, when the transcoded individual sub-resources are sent to the client, a picture-to-be-transmitted indicator is also carried for instructing the client to continue maintaining the connection with the transcoding server and wait to receive the picture information.

In step 7, the client performs local display when receiving the transcoded individual sub-resources.

In this step, when performing local display, the client first displays a default picture local to the client in the reserved typesetting space, and the effect map is as shown in FIG. 5. Of course, the drawing is only illustrated taking a commonly used webpage as an example, and the scope of the embodiment of the disclosure is not limited by the illustrated webpage.

In step 8, the picture processor detects whether the processor itself has cached the picture information after receiving the notification, and if yes, sends the cached picture information to the transcoding server; otherwise, downloads the picture information from the target website, and sends the downloaded picture information to the transcoding server.

It needs to be noted that the step 8 and the step 5 are two steps processed in parallel.

In step 9, after receiving the picture information sent by the picture processor, the transcoding server transcodes the picture information, and sends the transcoded picture information to the client; and so far, the transcoding server finishes responding to the request for accessing a webpage from the client.

In step 10, after receiving the picture information sent by the transcoding server, the client updates the currently displayed picture in the reserved typesetting space.

Exactly, in this step, after receiving the picture information, the client finds the corresponding reserved typesetting space according to the ID of the picture information, and updates the picture in the reserved typesetting space to the received corresponding picture information.

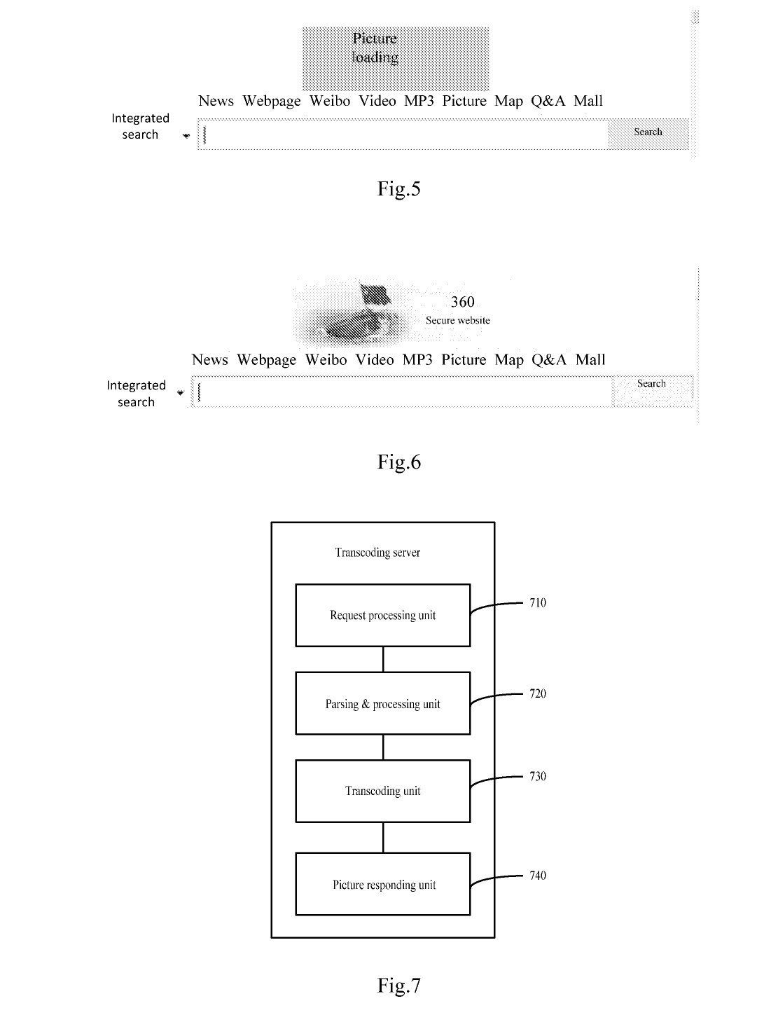

In particular, after receiving decoded picture information, the client then substitutes the picture information for the previous default picture according to the ID information, and the particular effect map is as shown in FIG. 6.

Of course, the above workflow is only directed to the situation in which individual sub-resources to be downloaded contain picture information, and the disclosure also applies to the situation in which no picture information is contained, namely, after the transcoding server parses an HTML document, when it is detected that the HTML document does not contain picture information, it directly downloads individual sub-resources from the target website, and transcodes the downloaded individual sub-resources and then sends them to the client.

To sum up, in the method of the embodiment of this disclosure, the download of picture information is separated out of the transcoding server, and is handled by the picture processor, the transcoding server need not wait for the complete download of the picture information before it can do webpage typesetting, such that the client may receive a response more rapidly so as to begin drawing page content; whereas after obtaining picture information sent by the picture processor, the transcoding server transcodes the picture information and then sends it to the client, and at this point, the client only needs to perform an update operation for picture information in a drawn page, which greatly improves the request response efficiency. And the client also need not send an additional number of requests, which will not waste network flow generated by the requests.

In addition, in the embodiment of this disclosure, for further improving the response efficiency, the picture processor employs a cache mechanism, thereby reducing the number of accessing a target website, improving the speed and increasing the processing capability of the system.

### Second Embodiment

As shown in FIG. 7, the embodiment of the disclosure further provides a transcoding server which particularly comprises:

a request processing unit 710 configured to receive a request for accessing a webpage from a client and obtain an HTML document from a target website based on the request;

a parsing & processing unit 720 configured to parse the HTML document, and when it is detected that the HTML document contains picture information, notify a picture processor and downloading individual sub-resources except for the picture information from the target website;

a transcoding unit 730 configured to transcode the downloaded individual sub-resources, reserve a typesetting space for the picture information when transcoding, and send them to the client after the completion of transcoding; and

a picture responding unit 740 configured to obtain the picture information in the HTML document fed back by the picture processor, and transcode the picture information and then send it to the client.

The above are the basic functional modules of the transcoding server provided by the embodiment of the disclosure, and in the following, the particular technical details of the transcoding server of the embodiment of the disclosure implementing the technical objects of the disclosure will be described by further elucidating functionally the individual functional modules.

In particular, the transcoding unit 730 is further configured to, when sending the transcoded individual sub-resources to the client, carry a picture-to-be-transmitted indicator for instructing the client to maintain the current connection.

The transcoding unit 730 is further configured to detect whether the size information of a picture is contained in the HTML document parsed by the parsing & processing unit 720, and if yes, reserve a typesetting space for the picture information based on the size information; or otherwise, reserve a typesetting space for the picture information based on a preset fixed size.

The transcoding unit 730 is further configured to, when reserving a typesetting space for the picture information, set the ID of the reserved typesetting space to match the ID of the picture information.

The picture responding unit 740 is further configured to, when the picture information is obtained, obtain the typesetting space reserved for the picture information according to the ID information of the picture information, and transcode the picture information based on the reserved typesetting space.

Furthermore, in the embodiment of the disclosure, when it is detected that the HTML document does not contain picture information, the parsing & processing unit 720 directly downloads individual sub-resources from the target website; whereas the transcoding unit 730 transcodes the downloaded individual sub-resources and then sends them to the client, thereby accomplishing the procedure of webpage transcoding.

### Third Embodiment

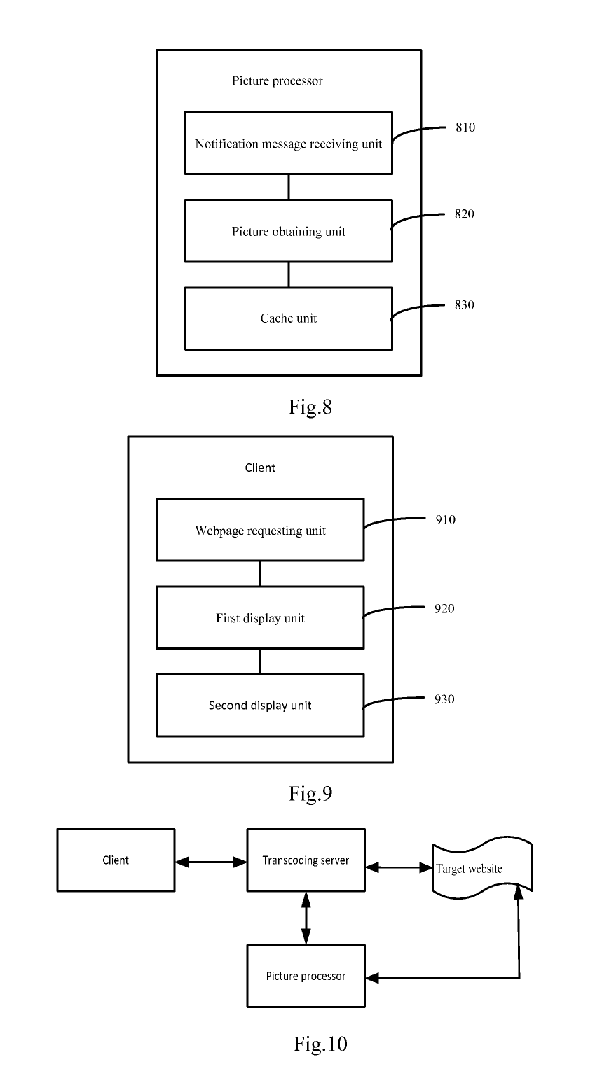

As shown in FIG. 8, the embodiment of the disclosure further provides a picture processor which particularly comprises:

a notification message receiving unit 810 configured to receive a notification message for obtaining picture information sent by a transcoding server;

a picture obtaining unit 820 configured to detect whether picture information requested to be obtained by a transcoding server has been cached in it, and if yes, feed the cached picture information back to the transcoding server; otherwise, download the picture information from a target website and then feed it back to the transcoding server; and

a cache unit 730 configured to cache locally picture information downloaded from the target website.

### Fourth Embodiment

As shown in FIG. 9, the embodiment of the disclosure further provides a client comprising:

a webpage requesting unit 910 configured to send a request message for accessing a webpage to a transcoding server;

a first display unit 920 configured to receive individual sub-resources except for picture sent by the transcoding server for webpage display which are transcoded and have a reserved picture typesetting space;

a second display unit 930 configured to receive transcoded picture information sent by the transcoding server, and display the picture information in the reserved picture typesetting space.

The above are the basic functional modules of the client provided by the embodiment of the disclosure, and in the following, the particular technical details of the client of the embodiment of the disclosure implementing the technical objects of the disclosure will be described by further elucidating functionally the individual functional modules.

In particular, the first display unit 920 is further configured to, after receive the transcoded individual sub-resources, detect whether a picture-to-be-transmitted indicator is carried, and if yes, continue maintaining the connection with the transcoding server.

Preferably, the first display unit 920 is further configured to, when performing webpage display, display a local default picture in the reserved picture typesetting space.

The second display unit 930 is further configured to, when receiving the transcoded picture information sent by the transcoding server, match a picture typesetting space corresponding to the picture information based on the ID information of the picture information, and display the received picture information in the picture typesetting space.

### Fifth Embodiment

As shown in FIG. 10, a system for webpage transcoding provided by the embodiment of the disclosure, which system comprises the transcoding server of the second embodiment, the picture processor of the third embodiment, and the client provided by the fourth embodiment.

It needs to be noted that, in case of no confliction, embodiments in the disclosure and features in the embodiments may be arbitrarily combined with each other.

Embodiments of the individual components of the disclosure may be implemented in hardware, or in a software module running on one or more processors, or in a combination thereof. It will be appreciated by those skilled in the art that, in practice, some or all of the functions of some or all of the components in a system for webpage transcoding according to individual embodiments of the disclosure may be realized using a microprocessor or a digital signal processor (DSP). The disclosure may also be implemented as a device or apparatus program (e.g., a computer program and a computer program product) for carrying out a part or all of the method as described herein. Such a program implementing the disclosure may be stored on a computer readable medium, or may be in the form of one or more signals. Such a signal may be obtained by downloading it from an Internet website, or provided on a carrier signal, or provided in any other form.

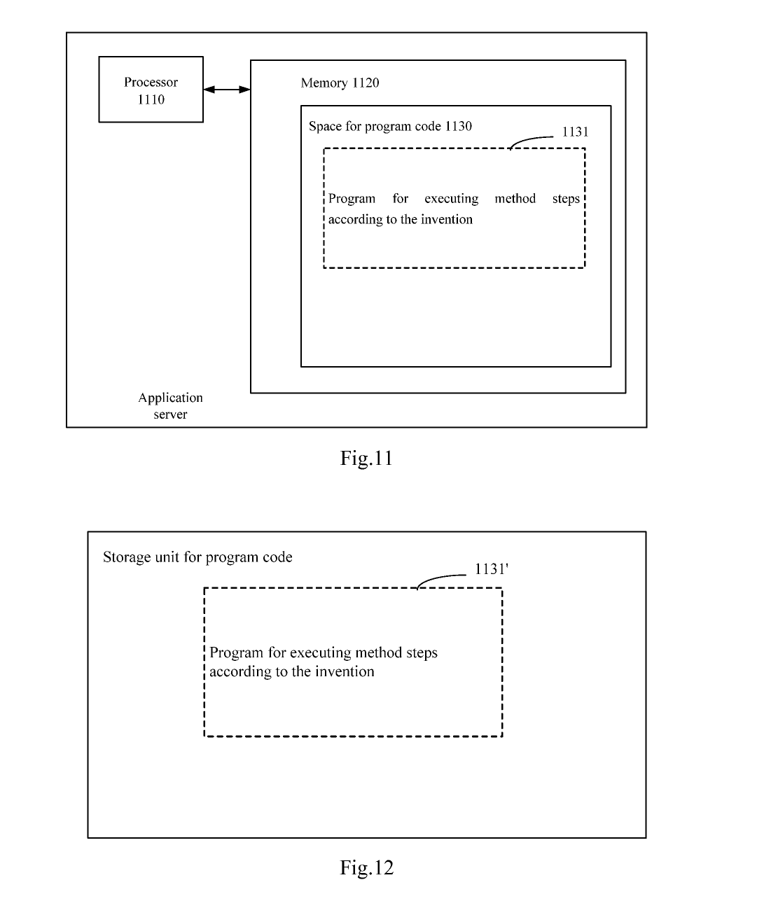

For example, FIG. 11 shows a server which may carry out a method for webpage transcoding according to the disclosure, e.g., an application server. The sever traditionally comprises a processor 1110 and a computer program product or a computer readable medium in the form of a memory 1120. The memory 1120 may be an electronic memory such as a flash memory, an EEPROM (electrically erasable programmable read-only memory), an EPROM, a hard disk or a ROM. The memory 1120 has a memory space 1130 for a program code 1131 for carrying out any method steps in the methods as described above. For example, the memory space 1130 for a program code may comprise individual program codes 1131 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 12. The storage unit may have a memory segment, a memory space, etc. arranged similarly to the memory 1120 in the server of FIG. 11. The program code may for example be compressed in an appropriate form. In general, the storage unit comprises a computer readable code 1131′, i.e., a code which may be read by e.g., a processor such as 1110, and when run by a server, the codes cause the server to carry out individual steps in the methods described above.

“An embodiment”, “the embodiment” or “one or more embodiments” mentioned herein implies that a particular feature, structure or characteristic described in connection with an embodiment is included in at least one embodiment of the disclosure. In addition, it is to be noted that, examples of a phrase “in an embodiment” herein do not necessarily all refer to one and the same embodiment.

In the specification provided herein, a plenty of particular details are described. However, it can be appreciated that an embodiment of the disclosure may be practiced without these particular details. In some embodiments, well known methods, structures and technologies are not illustrated in detail so as not to obscure the understanding of the specification.

It is to be noted that the above embodiments illustrate rather than limit the disclosure, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The disclosure may be implemented by means of a hardware comprising several distinct elements and by means of a suitably programmed computer. In a unit claim enumerating several means, several of the means may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the disclosure. Therefore, for those of ordinary skills in the art, many modifications and variations are apparent without departing the scope and spirit of the appended claims. For the scope of the disclosure, the disclosure of the disclosure is illustrative, but not limiting, and the scope of the disclosure is defined by the appended claims.

1. A method for webpage transcoding, comprising:
obtaining a Hypertext Markup Language (HTML) document from a target website based on a client request;
parsing the HTML document, and when it is detected that the HTML document contains picture information, notifying a picture processor and downloading individual sub-resources except for the picture information from the target website;
transcoding the downloaded individual sub-resources, and sending them to the client after the completion of transcoding, wherein reserving a typesetting space for the picture information when transcoding; and
obtaining the picture information in the HTML document fed back by the picture processor, and transcoding the picture information and then sending it to the client.

2. The method as claimed in claim 1, comprising:
carrying a picture-to-be-transmitted indicator when sending the transcoded individual sub-resources to the client;
after receiving the transcoded sub-resources, the client displaying the sub-resources locally, detecting whether a picture-to-be-transmitted indicator is carried, and if yes, continuing maintaining the current connection relationship, and waiting to receive the picture information.

3. The method as claimed in claim 1, wherein reserving a typesetting space for the picture information when transcoding further comprises:
detecting whether the size information of a picture is contained in the parsed HTML document, and if yes, reserving a typesetting space for the picture information based on the size information; otherwise, reserving a typesetting space for the picture information based on a preset fixed size.

4. The method as claimed in claim 1, further comprising:
after receiving the notification, the picture processor detecting whether the processor itself has cached the picture information, and if yes, feeding back the cached picture information; otherwise, downloading the picture information from the target website, and feeding back the downloaded picture information.

5. The method as claimed in claim 1, further comprising:
after receiving the transcoded individual sub-resources, the client displaying a local default picture in the reserved typesetting space.

6. The method as claimed in claim 5, further comprising: the local default picture displayed by the client being a waiting-for-download identification picture indicating that a picture is being downloaded.

7. The method as claimed in claim 1, further comprising:
when reserving a typesetting space for the picture information, setting the ID of the reserved typesetting space to match the ID of the picture information; and
when obtaining the picture information, obtaining the typesetting space reserved for the picture information according to the ID information of the picture information, and transcoding the picture information based on the reserved typesetting space.

8. The method as claimed in claim 7, further comprising:
after receiving the transcoded picture information, the client matching the reserved typesetting space corresponding to the picture information based on the ID information of the picture information, and displaying the received picture information in the reserved typesetting space.

9. The method as claimed in claim 1, further comprising:
when it is detected that no picture information is contained in the HTML document, directly downloading individual sub-resources from the target website, and transcoding the downloaded individual sub-resources and then sending them to the client.

10. A transcoding server, comprising:
at least one processor to execute a plurality of units comprising:
a request processing unit configured to receive a request for accessing a webpage from a client and obtain an HTML document from a target website based on the request;
a parsing & processing unit configured to parse the HTML document, and when it is detected that the HTML document contains picture information, notify a picture processor and download individual sub-resources except for the picture information from the target website;
a transcoding unit configured to transcode the downloaded individual sub-resources, and send them to the client after the completion of transcoding, wherein reserve a typesetting space for the picture information when transcoding; and
a picture responding unit configured to obtain the picture information in the HTML document fed back by the picture processor, and transcode the picture information and then send it to the client.

11. The transcoding server as claimed in claim 10, wherein the transcoding unit is further configured to, when sending the transcoded individual sub-resources to the client, carry a picture-to-be-transmitted indicator for instructing the client to maintain the current connection.

12. The transcoding server as claimed in claim 10, wherein the transcoding unit is further configured to detect whether the size information of a picture is contained in the HTML document parsed by the parsing & processing unit, and if yes, reserve a typesetting space for the picture information based on the size information; otherwise, reserve a typesetting space for the picture information based on a preset fixed size.

13. The transcoding server as claimed in claim 10, wherein
the transcoding unit is further configured to, when reserving a typesetting space for the picture information, set the ID of the reserved typesetting space to match the ID of the picture information; and
the picture responding unit is further configured to, when the picture information is obtained, obtain the typesetting space reserved for the picture information according to the ID information of the picture information, and transcode the picture information based on the reserved typesetting space.

14. The transcoding server as claimed in claim 10, wherein
the parsing & processing unit is further configured to, when it is detected that the HTML document does not contain picture information, directly download individual sub-resources from the target website; and
the transcoding unit is further configured to transcode the downloaded individual sub-resources and then sends them to the client.

15. (canceled)

16. A client, comprising:
at least one processor to execute a plurality of units comprising:
a webpage requesting unit configured to send a request message for accessing a webpage to a transcoding server;
a first display unit configured to receive individual sub-resources sent by the transcoding server for webpage display which are transcoded and have a reserved picture typesetting space; and
a second display unit configured to receive transcoded picture information sent by the transcoding server, and display the picture information in the reserved picture typesetting space.

17. The client as claimed in claim 16, wherein
the first display unit is further configured to, after receive the transcoded individual sub-resources, detect whether a picture-to-be-transmitted indicator is carried, and if yes, continue maintaining the connection with the transcoding server.

18. The client as claimed in claim 16, wherein the first display unit is further configured to, when performing webpage display, display a local default picture in the reserved picture typesetting space.

19. The client as claimed in claim 16, wherein the second display unit is further configured to, when receiving the transcoded picture information sent by the transcoding server, match the picture typesetting space corresponding to the picture information based on the ID information of the picture information, and display the received picture information in the picture typesetting space.

20. (canceled)

21. (canceled)

22. (canceled)
